(19) United States
(12) Patent Application Publication
(10) Pub. No.: US 2018/0342043 A1
(43) Pub. Date: Nov. 29, 2018

(54) Auto Scene Adjustments For Multi Camera Virtual Reality Streaming

(71) Applicant: Nokia Technologies Oy, Espoo (FI)

(72) Inventors: Basavaraja Vandrotti, Sunnyvale, CA (US); Muninder Veldandi, Sunnyvale, CA (US); Arto Lehtiniemi, Lempaala (FI); Daniel Andre Vaquero, Sunnyvale, CA (US)

(73) Assignee: Nokia Technologies Oy

(21) Appl. No.: 15/602,356

(22) Filed: May 23, 2017

(51) Int. Cl. G06T 3/00; H04N 5/232; G06T 7/33; H04N 13/00; G06T 3/40; H04N 5/247

(52) U.S. Cl. CPC G06T 3/0068; H04N 5/23238; G06T 7/337; G06T 2207/10016; G06T 3/4038; H04N 5/247; H04N 13/0014

(57) ABSTRACT

Embodiments herein select first and second panoramic images from respective first and second video streams, each comprising a series of stitched images captured by multiple cameras of respective first and second non-co-located video camera arrays. These arrays may be capturing live video for virtual reality rendering. A rotation is computed between the first and second panoramic images such that, when applied, the first and/or the second panoramic images are rotated relative to one another such that at least one common object is oriented to a common field of view position in both those panoramic images. The output can be variously manifested for different embodiments, for example the output can include a) the first video stream, the second video stream, and an indication of the computed rotation; and/or b) the first video stream and the second video stream with the computed rotation applied thereto.

### TECHNOLOGICAL FIELD

The described invention relates to capturing and streaming of virtual reality content using multiple virtual reality cameras at different locations.

### BACKGROUND

In the field of virtual reality (VR) often the user experience is created from camera arrays that produce 360° video. One example of such a camera array is the Nokia® Ozo® camera system which has multiple cameras each pointing in a different direction arrayed about a mostly spherical housing. VR Camera C3 shown at FIG. 1 represents an Ozo® camera array, which specifically has 8 cameras and 8 microphones for audio capture as well. One challenge in 360° video in general, and in multi-camera productions/streaming in particular, lies in managing the user's attention. When streaming or viewing video in multi-camera environments (sometimes referred to as immersive video) such as sporting/theater events and music concerts, there are occasional switches from one VR camera to another, and an important consideration for these camera transitions is to keep the user's focus of attention in the original scene captured by the currently viewing VR camera to match their attention in the new scene captured from the new VR camera. Keep in mind for a VR experience these cameras are capturing the same event from different viewing perspectives, and as the VR viewer perspective changes there may be a change to the camera outputting what the viewer sees. It should not be necessary for the VR user to look around after the camera view change to find the subject he/she was focused on prior to that change. This challenge becomes increasingly difficult as the VR user moves amongst stationary cameras, and when the cameras are also moving relative to the stationary or moving VR user.

The current state of the art in this regard is to stitch the video content from the different cameras of a given camera array together to form a panoramic view and manually pan across the different panoramic views of the different camera arrays when there is a switch between camera arrays. Stitching together different video streams of a VR camera array such as the Nokia® Ozo® is known in the art and is not detailed further herein. In a case where there are multiple VR camera arrays (static or moving for example mounted on a robotic arm or drone) used to capture a scene, when the VR user and/or the camera arrays are in motion it becomes increasingly difficult using this manual panning technique to keep the same object in the scene at the user's focus across a camera array switch, and even when this technique is effective generally it requires additional effort by the production director or his/her team. This is not a technique that is suitable for VR-casting live events. What is needed in the art is a way to effectively automate the process of transitioning the VR viewer's video as the view changes among different camera arrays and panning across the different content so as to maintain the user's immersive video experience when the user's viewpoint shifts from one camera array to another where the VR camera arrays are not co-located.

The following references may have teachings relevant to the invention described below:

U.S. Pat. No. 9,363,569 entitled Virtual Reality System Including Social Graph, issued on Jun. 7, 2016;

U.S. Pat. No. 9,544,563 entitled Multi-Video Navigation System, issued on Jan. 10, 2017;

U.S. Patent Application Publication No. 2013/0127988 entitled Modifying the Viewpoint of a Digital Image, published on May 23, 2013;

U.S. Patent Application Publication No. 2016/0352982 entitled Camera Rig and Stereoscopic Image Capture, published on Dec. 1, 2016;

International Patent Application Publication no. WO 11142767 entitled System and method for Multi-Viewpoint VideoCapture, published on Nov. 17, 2011; and

A paper entitled Multiview Video Sequence Analysis, Compression and Virtual Viewpoint Synthesis, by Ru-Shang Wang and Yao Wang [IEEE TRANSACTIONS ON CIRCUITS AND SYSTEMS FOR VIDEO TECHNOLOGY, vol. 10, no. 3; April, 2010; pp. 397-410].

### SUMMARY

According to a first aspect of these teachings there is a method comprising: selecting a first panoramic image from a first video stream comprising a series of stitched images captured by multiple cameras of a first video camera array; selecting a second panoramic image from a second video stream comprising a series of stitched images captured by multiple cameras of a second video camera array not co-located with the first camera array; computing a rotation between the first and second panoramic images such that, when applied, the first and/or the second panoramic images are rotated relative to one another such that at least one common object is oriented to a common field of view position in both the first and second panoramic images; and at least one of a) outputting the first video stream, the second video stream, and an indication of the computed rotation; and b) outputting the first video stream and the second video stream with the computed rotation applied thereto.

According to a second aspect of these teachings there is a computer readable memory storing executable program code that, when executed by one or more processors, cause an apparatus to perform actions comprising: selecting a first panoramic image from a first video stream comprising a series of stitched images captured by multiple cameras of a first video camera array; selecting a second panoramic image from a second video stream comprising a series of stitched images captured by multiple cameras of a second video camera array not co-located with the first camera array; computing a rotation between the first and second panoramic images such that, when applied, the first and/or the second panoramic images are rotated relative to one another such that at least one common object is oriented to a common field of view position in both the first and second panoramic images; and at least one of a) outputting the first video stream, the second video stream, and an indication of the computed rotation; and b) outputting the first video stream and the second video stream with the computed rotation applied thereto.

According to a third aspect of these teachings there is an apparatus comprising at least one computer readable memory storing computer program instructions and at least one processor. In this aspect the at least one memory with the computer program instructions is configured with the at least one processor to cause the apparatus to at least: select a first panoramic image from a first video stream comprising a series of stitched images captured by multiple cameras of a first video camera array; select a second panoramic image from a second video stream comprising a series of stitched images captured by multiple cameras of a second video camera array not co-located with the first camera array; compute a rotation between the first and second panoramic images such that, when applied, the first and/or the second panoramic images are rotated relative to one another such that at least one common object is oriented to a common field of view position in both the first and second panoramic images; and at least one of a) output the first video stream, the second video stream, and an indication of the computed rotation; and b) output the first video stream and the second video stream with the computed rotation applied thereto.

### BRIEF DESCRIPTION OF THE DRAWINGS

FIG. 1 is a conceptual diagram illustrating how 360 degree video is produced from multiple cameras of multiple camera arrays where simple video stitching is used to form the different panoramic video feeds from the different cameras.

FIG. 2 is similar to FIG. 1 illustrating stitching video feeds from three non-co-located VR cameras and rotating at least two of those feeds such that a common object in the field of view of each camera array's panoramic image is oriented in a common position within those fields of views.

FIG. 3 is similar to FIG. 2 but showing further detail of the stitching machine for an embodiment in which there are positional sensors associated with each of the cameras which are used to find the needed rotation.

FIG. 4 is similar to FIG. 2 but showing further detail of the stitching machine for an embodiment in which there are no positional sensors/magnetometers associated with the cameras providing the video feeds and the needed rotation is computed differently.

FIG. 5 is a process flow diagram summarizing certain embodiments of these teachings from the perspective of the stitching machine which also computes the needed rotations.

FIG. 6 is a high level schematic block diagram illustrating a video processing device/system that is suitable for practicing certain of these teachings.

### DETAILED DESCRIPTION

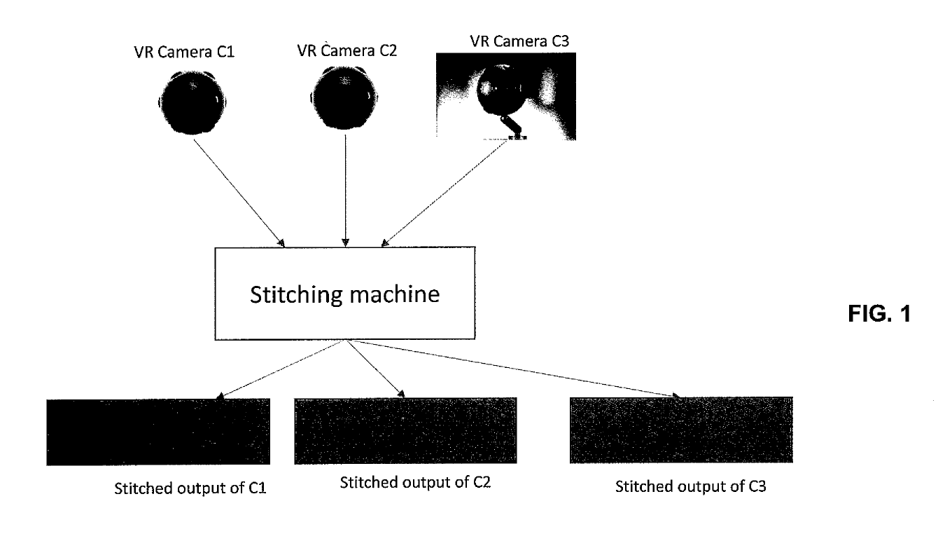

To better understand the advances these teachings offer, FIG. 1 is a conceptual diagram illustrating how 360 degree video is produced from multiple virtual reality cameras. Each camera of the Nokia® Ozo® array is capturing a field of view of about 195°; others like GoPro® capture about 170° so as an approximation we can say each sensor/camera of an array captures about 180°. The output of each such camera array is a 360° video stream made up of a series of panoramic images that are stitched together from the different images captured by the individual cameras of the array. Particularly for large events such as sporting contests, theater performances and musical concerts, multiple VR camera arrays may be placed at different locations about the event. In this case the multiple 360° video streams from the different VR camera arrays are fed to a stitching machine as FIG. 1 illustrates, which encodes and broadcasts these different-array video streams together to support many different VR viewers simultaneously seeing the event from many different VR perspectives. In other camera array embodiments stitching the different camera images together to form a stream of panoramic images may be performed within the camera array.

Since each VR camera array is placed at a different location, the 360° video output from each array will also be different because they are covering the same event from different locations. This results in objects captured at the same instant by different camera arrays appearing at different locations of the respective array's panoramic image as FIG. 1 illustrates for three different VR camera arrays C1, C2 and C3. For example, if we consider each panoramic video frame illustrated at FIG. 1 as spanning 360° with 0° as the center and each capturing the same object (shown as a face) from different perspectives, the frame from the 360° panoramic video of VR camera array Cl may have that object at −170° while the frame from the 360° panoramic video of VR camera array C2 has the same object at 0° and the frame from the 360° panoramic video of VR camera array C3 has that object captured at +170°. In this example if the director of the event switches from camera array C1 to array C3 and the user is watching the object which is at −170° degrees, suddenly the object disappears from the scene when the director switches the scene (the human stereoscopic field of view is roughly 114°). This degrades the VR experience quite substantially; experiencing such a gross departure from any real-world experience removes the user's mind from the virtual reality immersion effect and serves to remove them from the feeling of being physically present at the event represented by the 360 degree video. The degradation is less severe if for example the director switched between camera arrays that presented the common object at zero degrees and at +60 degrees for example, since the object would still be present within the user's field of view in the first perspective/first array view though that object would still be instantaneously ‘moved’ from the user's perspective across the span of two video frames when the array feeding the VR output presented to this user is switched.

The problem at FIG. 1 is not in the basic technical step of stitching images from multiple cameras of a given camera array but in the fact that switching between the different panoramic views of different arrays that are not co-located does not always reproduce an immersive user experience. As particularly detailed above this leads to the adverse result of a common object such as the face in FIG. 1 ‘jumping’ from one location in the viewer's field of view to another (or even completely disappearing or appearing from seemingly nowhere) in the time span of two video frames.

As used herein, cameras are considered co-located when the images/video they produce virtualize a user's presence in a singular location in 3-dimensional space, and are not co-located when the images/video they produce virtualize a user in different geographic locations. Thus all the cameras of an individual camera array such as those of a single Nokia® Ozo® device are all considered to be co-located cameras, while any camera of one Ozo® device is not co-located with any camera of a different Ozo® device that is disposed for example one meter away from the first Ozo® device.

As with the description of FIG. 1 above, the description below may refer to a panoramic image (or similarly a frame of video) as opposed to the full video streams which are simply a series of panoramic images from a given camera array to simplify the explanation herein. Embodiments of these teachings operate on the individual panoramic images captured by individual non-co-located cameras that when captured serially in time make up the video stream. Further, it is understood that for stereoscopic virtual reality video the image of a given scene may be slightly different for the left versus right eye; the Nokia® Ozo® achieves this by capturing two pixel layers using broadly overlapping fields of view for the cameras of a given Ozo® device. Depending on the VR camera array capturing the images/video these teachings can apply for operating on those different-eye panoramic images separately even though the specific processing of left-eye and right-eye video streams is substantially identical. In other embodiments the video stream is stereoscopic as transmitted, and the stereoscopic effect produced by slightly different left-eye and right-eye images/video is realized only at the end user VR device. In some embodiments the rotations described herein are applied only at the end-user VR headset or at a video processing device that provides the video feed directly to that end-user VR headset, whereas in other embodiments the video feeds from the different VR camera arrays are rotated as described herein prior to their final transmission to the end-user VR device.

While the examples below include video stream inputs from three different non-co-located camera arrays, the minimum embodiments of these teachings can operate on two such streams and, apart from processing capacity and processing speed constraints, there is no upper limit to the number of video streams from different camera arrays these teachings can rotate relative to one another so as to maintain the immersive video environment for the user. Considering only two video stream embodiments, certain of these teachings can be summarized as selecting first and second panoramic images from respective first and second video streams, each comprising a series of stitched images captured by multiple cameras of respective non-co-located first and second video camera arrays. A rotation between those first and second panoramic images is computed such that when this rotation is applied (to one or both of the panoramic images, in correspondence with how the rotation is computed), the first and/or the second panoramic images are rotated relative to one another so that an object common to both panoramic images is oriented to the same position in the field of view of both those first and second panoramic images. Outputting these video streams after that rotation is computed can take a few different forms as detailed more particularly below. In practice these video streams will typically be encoded prior to transmission but that is peripheral to the teachings herein and is known in the art so will not be further explored herein.

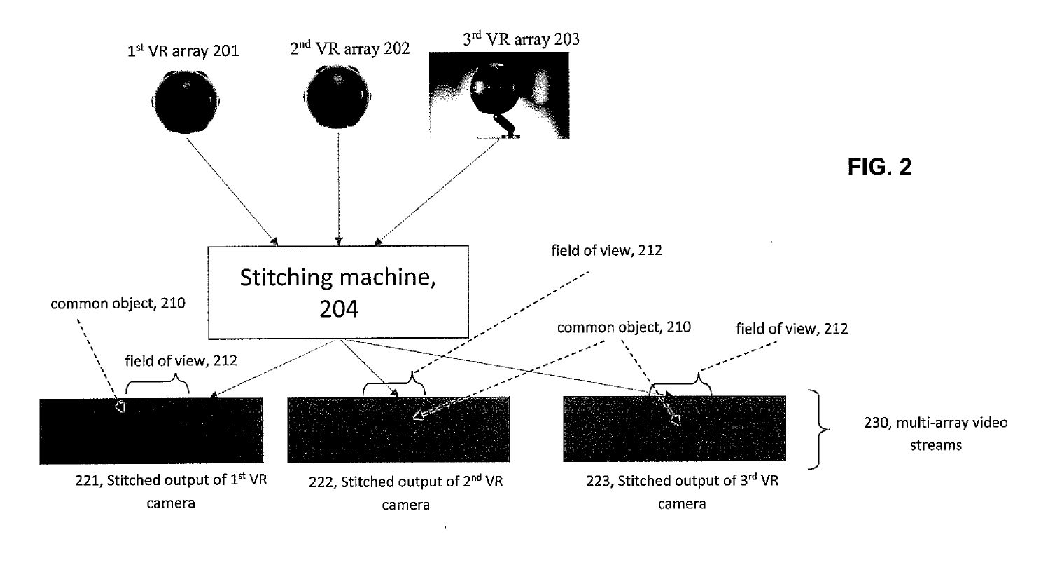

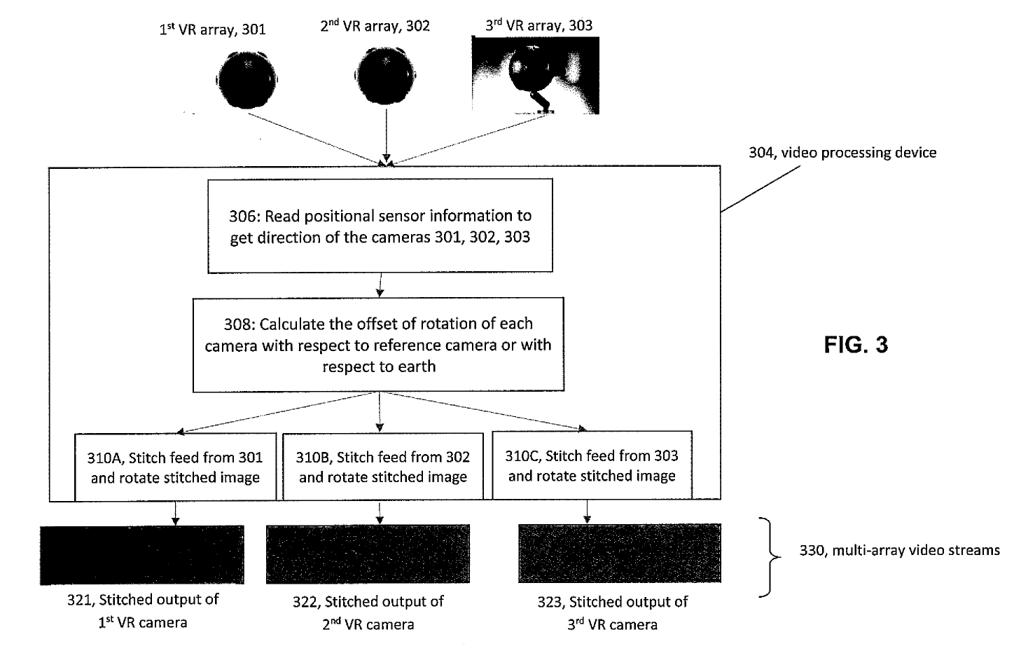

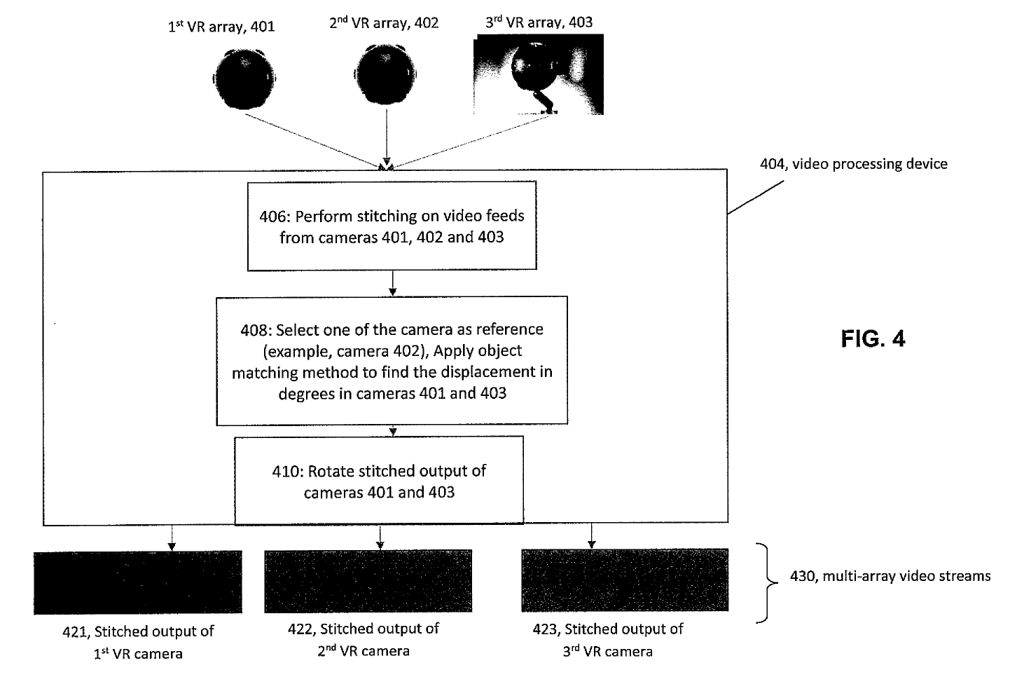

FIG. 2 is similar to FIG. 1 and illustrates the above summary overview for three non-co-located VR camera arrays 201, 202 and 203. Each camera of these arrays 201, 202, 203 contributes a portion to the stitched panoramic images that form the video streams from these camera arrays, and the stitching machine 204 operates to form the first panoramic image 221 from the first VR camera array 201, the second panoramic image 222 from the second VR camera array 202, and the third panoramic image 223 from the third VR camera array 203. In some non-limiting embodiments the stitching machine 204, which may be embodied as the processor(s) and computer readable memory storing executable program code, may in addition to stitching these images also compute the rotations of these images 221, 222, 223 relative to one another for implementing these teachings as further detailed below. In this regard the stitching machine 204 produces the stitched panoramic images similar to those shown at FIG. 1 but further selects a reference direction and computes a rotation for each pair of panoramic images from different arrays (these images simultaneously captured by the respective arrays) so that when the rotations are performed on these images one or more common objects 210 are at a same position (zero degrees or centered as FIG. 2 illustrates) in the field of view 212 for all those panoramic images 221, 222, 223. What is output are the multiple video streams 230 from the different arrays 201, 202, 203, with either an indication of those computed rotations (if the rotation is to be applied downstream such as at the end-user VR device) or with the computed rotations applied to corresponding ones of the different-array video streams. The reference direction is detailed further below with respect to FIGS. 3-4.

The field of view 212 for these panoramic images 221, 222, 223 from the different VR camera arrays 201, 202, 203 may be less than the entire panorama of the image; for example it may be the field of view of one specific camera of its host array whose contribution to the panoramic image includes the common object 210. Since a given VR user's field of view is much less than that represented by the panoramic images 221, 222, 223 (360° in this example), to address a given VR user's changeover of VR feed between different cameras of different arrays we only need to provide a rotation to align objects in that user's field of view during the camera changeover. The human stereoscopic field of vision is about 114° so for a given user it matters not that for a given rotation certain objects on the 360° panoramic images that are well outside that user's current 114° field of vision are not aligned to the same position in the overall panoramic images, because this VR user will not see them during the camera changeover. All that matters for any given user is aligning the objects within his/her field of vision during the changeover of camera arrays to the same position within his field of vision. We use field of view 212 to isolate that portion of the panoramic images 221, 222, 223 so as to include only the objects 210 relevant to this specific changeover between specific cameras. Since different VR end-users are moving independently of one another, the feed to one user may change from camera 1/array1 to camera 1/array2 while that of another user may change from camera 1/array1 to camera 3/array2, and so forth. The rotations computed herein are in some embodiments done on all such logically possible VR feed changeovers and the rotations are actually applied to the relevant video stream or streams at the end-user VR device to correspond with that VR user's head movements which select the field of view 212. The following description details how the rotations are calculated for two possible feed changeovers and thus has three panoramic images 221, 222, 223 from three different VR camera arrays 201, 202, 203.

Assume prior to the VR feed change the user was viewing the center of the second panoramic image 222 that FIG. 2 illustrates. If for example the user is moving virtually away from the object 212 the VR feed would change over to the field of view 212 of the third panoramic image 223 from the third array 203 and the object is in the same position in that field of view 212 but smaller. If instead the user is moving virtually towards the object 212 the VR feed would change over to the field of view 212 of the first panoramic image 221 from the first array 201 and the object is in the same position in that field of view 212 but larger. Embodiments of these teachings may automatically smooth the viewer's perception of that common object's movement away or towards as the user's VR feed changes from one video stream captured by one array to another video stream captured by another array. Different sizes of the common object 210 in the panoramic images 221, 222, 223 of these different video streams/feeds are exaggerated in the figures herein to better illustrate the concept, but in practice the size difference between two simultaneously-captured frames from the different video streams would typically not be large in order to maintain the immersive video environment that mimics reality. In this example there may be different rotations computed of the first and third panoramic images 221, 223 relative to the second 222, or computations for rotating all three images 221, 222, 223 may be performed so that when the rotations are applied to the video streams at the instant of those images 221, 222, 223 the common object 210 is oriented to a common position in the field of view 212.

FIGS. 3-4 detail different ways to compute these rotations. While in some embodiments the rotation computations are performed by the stitching machine, in other embodiments the stitching function and the rotational computation function may be independent and performed by distinct and even physically separated entities of a video processing system, so the described video processing device 304, 404 in those figures may or may not also perform stitching of the panoramic images from each different camera array. In general across these figures the camera arrays, the video streams of images they output to the stitching machine to generate the panoramic images, and the video streams from the multiple arrays that are towards the VR end use devices are similar to those described with reference to FIG. 2 and so common details will not be repeated for each of these different figures. In general, FIG. 2 shows that the stitching machine 204 that additionally computes the rotations uses the captured video content (along with positional information of the cameras that captured that video as detailed below) to produce the multi-array video streams for output 230 in such way that the objects 210, for example at 0 degrees, appear at 0 degrees in each of the panoramic images 221, 222, 223 of the different-array videos.

FIG. 3 is similar to FIG. 2 but showing further detail of the video processing device 304 for an embodiment in which there are positional sensors associated with each of the cameras of the arrays 301, 302, 303. Such positional sensors may be for example magnetometers which identify the direction in which the camera was facing when capturing the video that is being processed. These embodiments can use this sensor data of camera directions to find the direction for the field of view 212 in the panoramic images 321, 322, 323 and compute the rotations so as to align those field of view directions for the output video streams 330.

Along with each input video stream from the different arrays 301, 302, 303 there is provided sensor data that identifies the direction the various cameras of those arrays was facing at the time the video was captured. The video processing device 304 of FIG. 3 reads this information at block 306 to get the facing direction of the relevant cameras of these arrays 301, 302, 303. With this directional information for each camera, block 308 calculates for each camera direction the offset of rotation with respect to some reference direction, which for example can be one of the camera directions or a magnetic direction of the earth. This offset of rotation is the rotation angle to be applied for the panoramic images 321, 322, 333 that are within the video feeds from that respective arrays that house those cameras. Applying those computed rotations is shown in FIG. 3 as 310A, 310B and 310C for the three different video feeds. Of course if a camera direction is chosen as the reference direction the offset of rotation for that camera will be zero and the other camera rotation offsets will be non-zero. The end result as FIG. 3 illustrates is that the multiple video streams from the multiple arrays that are output 330 are produced by rotating at least two of the three video streams relative to one another, at the time of the panoramic images 321, 322, 323, so as to orient at least one common object (the face) to a common field of view position (zero degrees as shown) in those panoramic images.

The principles of these teachings can also be put into practice when the VR camera arrays do not have positional sensors/magnetometers, and this embodiment is demonstrated by FIG. 4. In this regard the video streams output from the different camera arrays 401, 402, 403 to the video processing device 404 will not have sensor data associated with them, and the video processing device machine 404 begins by stitching the different camera images together to form three video feeds at block 406 from the three arrays 401, 402, 403. Alone this would result in panoramic images that is subject to instantaneous movements of a common object when a VR user changes from one video feed to the other, or sudden disappearance or appearance of an object which is a problem with conventional VR techniques especially for live VR video. The FIG. 4 embodiment performs the relevant video feed/image rotations after this initial stitching step 406. At block 408 one of the camera arrays (more precisely, one of the camera video feeds) is chosen as a reference; this is similar to the reference direction described above for FIG. 3. Object matching amongst images and video is known in the art and in this case entails tracking and aligning one or multiple common objects in simultaneously-captured panoramic images 421, 422, 423 of the different video feeds from the different cameras 401, 402, 403. In some embodiments where there is an audio feed corresponding to the video feed from the camera arrays this object matching can further utilize audio matching, because there will be some directionality to audio captured by microphones of a VR camera array. This technique can be used to estimate at block 408 the rotational displacement of each video feed relative to the reference feed, in this example the rotational displacement is found for the panoramic images 421, 423 within the videos from cameras 401 and 403 relative to the panoramic image 422 within the video from camera 402 which is selected as the reference. The portions of the stitched output from block 406 corresponding to those non-reference cameras are then rotated at block 410 according to the respective rotational displacements that were computed at block 408 for the field of view in the panoramic images 421, 423 originated from camera arrays 401 and 403, and if these rotational displacements are applied by the video processing device 404 the output 430 is then the multiple-array video streams 430 with the common object (face) oriented to a same position within the field of view across each of these video streams.

Because digital images are being processed by the video processing device 404 of FIG. 4, if that device 404 also performs the stitching the rotation 410 can occur after the panoramic images 421, 422, 423 are stitched at block 406 as FIG. 4 specifically illustrates, or in other implementations of these teachings the rotations can be applied even prior to the stitching.

Embodiments of these teachings provide the technical effect of improving the VR user experience by enabling the user to seamlessly switch between different cameras of different VR camera arrays while objects in his/her field of view are disposed at the same position within that field of view. Another technical effect is that embodiments of these teachings fully automate the video panning so no manual inputs are needed, which is a tremendous advantage when the video content from multiple VR camera arrays is a live event such as a sporting event or a concert.

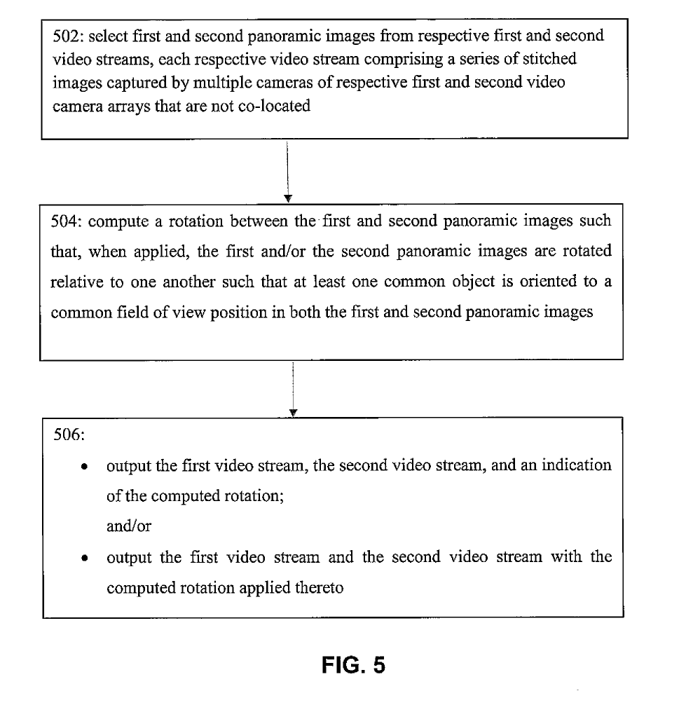

FIG. 5 is a process flow diagram that summarizes some of the above aspects from the perspective of the stitching machine that takes as inputs the video feeds from two or more non-co-located cameras. At block 502 the video processing device selects a first panoramic image from a first video stream comprising a series of stitched images captured by multiple cameras of a first video camera array, and also selects a second panoramic image from a second video stream comprising a series of stitched images captured by multiple cameras of a second video camera array not co-located with the first camera array. At block 504 the video processing device computes a rotation between the first and second panoramic images such that, when applied, the first and/or the second panoramic images are rotated relative to one another such that at least one common object is oriented to a common field of view position in both the first and second panoramic images.

Block 506 describes the output from the video processing device. In some embodiments that output includes the first video stream, the second video stream, and an indication of the computed rotation. In these embodiments neither the video streams nor the panoramic images are rotated; the rotation is applied downstream such as at the VR end-user device itself which applies the rotation and any smoothing that may be in the implementing software when the VR user's movements through the virtual space result in the changeover of cameras and arrays that this rotation reflects. In some other embodiments the output from the video processing device is the first video stream and the second video stream with the computed rotation applied to one or both of them. In this regard the applied rotation corresponds to how the rotation was calculated, so for example if the panoramic images are 321 and 322 of FIG. 3 and the rotation was computed for rotating image 321 to align with a reference direction given by image 322 then the calculated rotation will be applied only the 321 image, whereas if the rotation was computed to rotate both image 321 and 322 to align with a reference direction with respect to earth then the calculated rotation will be two values of which one is to be applied only to the 321 image and the other is to be applied to the 322 image so as to achieve the result that block 504 describes for the common object.

In a specific embodiment described above with respect to FIG. 3, the video processing device receives with the first video stream sensor data that identifies a first direction at which a first camera of the first camera array was facing while capturing a portion of the first panoramic image in which the common object is in the field of view; and the video processing equipment further receives with the second video stream sensor data that identifies a second direction at which a second camera of the second camera array was facing while capturing a portion of the second panoramic image in which the common object is in the field of view. As detailed above more particularly, in this embodiment the rotation computation at block 504 comprises a) selecting a reference direction; b) aligning one or both of the first and second directions to the reference direction; and c) computing the rotation in relation to the reference direction.

More specifically, the FIG. 3 example had the video processing device calculating a first rotation offset between the first direction and the reference direction; and/or (depending on whether a camera direction is chosen as the reference direction) calculating a second rotation offset between the second direction and the reference direction. In this case if the indication of the computed rotation that block 506 has as being output is an indication of the calculated first and/or second rotation offset, depending on what was calculated. As mentioned above, the reference direction may be selected by choosing one of the first and second directions.

In a specific embodiment described above with respect to FIG. 4 sensor data is not used to get the camera directions. In these example embodiments the video processing device selects as the reference direction a viewpoint direction of a portion of the first panoramic image in which the common object is in the field of view, and then calculates a rotational displacement between the reference direction and a viewpoint direction of a portion of the second panoramic image in which the common object is in the field of view. For the case of the output at block 506 being the first-listed bullet, the indication of the computed rotation that is output is an indication of the calculated rotational displacement.

Each of the FIG. 3 and FIG. 4 examples used video feeds from three different camera arrays. In this case block 502 of FIG. 5 would be expanded such that the video processing device selects a third panoramic image from a third video stream comprising a series of stitched images captured by multiple cameras of a third video camera array which is not co-located with the first nor the second video camera arrays. The rotation block 504 describes will then be expanded to include a first computed rotation that when applied rotates the first panoramic image relative to the second panoramic image; and also a second rotation between at least the second and third panoramic images such that, when applied, the third panoramic image is rotated relative to the second panoramic image such that the at least one common object is oriented to the common field of view position in both the second and third panoramic images. For these three video feeds being processed then the output at block 506 will change to:

the first video stream, the second video stream, the third video stream and indications of the first and second computed rotations; and/or

the first video stream and the second video stream and the third video stream with the first and second computed rotation applied thereto.

For the case in which the video streams represent a live event such as a sporting event or a concert, the process FIG. 5 describes is performed dynamically as the first and second camera arrays capture that live event via the respective first and second video streams. For example, each of these virtual reality camera arrays may comprise at least 5 cameras with overlapping fields of view, and in some embodiments also microphones. FIG. 5 and the examples specifically describe alignment of one field of view among the panoramic images from the different camera arrays but for the case there may be many VR end users moving among the virtual reality space independently different alignments of different fields of view may be necessary to account for one viewer's VR feed changing between for example array 1/camera1 and array2/camera1, while at the same time (same video frame) another viewer's VR feed changes between array1/camera1 and array2/camera3. To account for all these possibilities of VR viewers changing over with different camera pairs of those two arrays during that video frame, the process of FIG. 5 may be performed multiple times across multiple common objects of the first and second panoramic images, wherein each performance of the FIG. 5 process computes a rotation such that one of the multiple common objects is oriented to a different common field of view position in both the first and second panoramic images. For any of the embodiments herein more than one common object can be used per rotation calculation for improved precision; each different common object would be aligned to a common position that is common for that object but not so for other objects being used for that same alignment/rotation calculation.

Whether for a live event or recorded on a computer memory and VR-cast at a later time, what is detailed at FIG. 5 for a single video frame (the panoramic images) may be performed continuously on the first and second video streams such that each pair of first and second panoramic images on which FIG. 5 operates are simultaneously captured by the respective first and second video camera arrays. In this regard continuously does not necessarily mean every video frame; it may be every periodic video frame or it may be on every sequential or periodic frame of a specific type or types (such as reference frames where the video is compressed to a series of reference frames and corresponding enhancement frames of various enhancement levels).

FIG. 5 represents various embodiments of how these teachings may be implemented. In one implementation FIG. 5 reflects a method; in another these teachings may be embodied as a computer readable memory storing executable program code that, when executed by one or more processors, cause an apparatus such as the described video processing device or system to perform the steps that FIG. 5 details. In a further embodiment these teachings may be incorporated in an apparatus such as the described video processing device (which may or may not also include the stitching machine functionality) that comprises at least one memory storing computer program instructions and at least one processor. In this latter case the at least one memory with the computer program instructions is configured with the at least one processor to cause the apparatus to perform actions according to FIG. 5.

Various of the aspects summarized above with respect to FIG. 5 may be practiced individually or in any of various combinations. While the above description and FIG. 5 are from the perspective of a video processing device, the skilled artisan will recognize that such a video processing device may be implemented as a system utilizing distributed components such as processors and computer readable memories storing video feeds and executable program instructions that are not all co-located with one another, for example in a cloud-based computing environment and/or in a software as a service business model in which the executable program is stored remotely and run by one or more non-co-located processors using Internet communications.

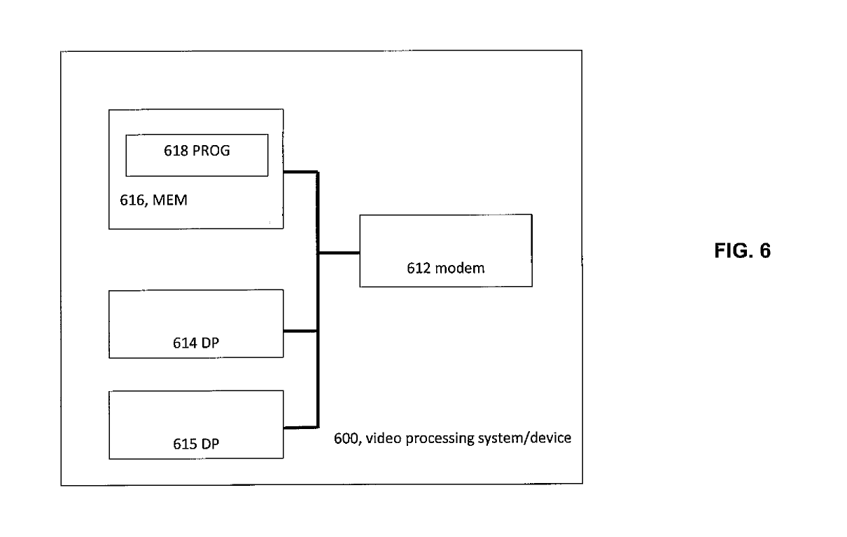

FIG. 6 is a high level diagram illustrating some relevant components of a stitching machine, or more generally a video processing device or system 600 that may implement various portions of these teachings. The video processing device/system 600 includes a controller, such as a computer or a data processor (DP) 614 (or multiple ones of them), a computer-readable memory medium embodied as a memory (MEM) 616 (or more generally a non-transitory program storage device) that stores a program of executable computer instructions (PROG) 618, and a suitable interface 612 such as a modem to the communications network that will be used to distribute the combined multi-camera video stream to multiple dispersed VR user devices. In general terms the video processing device/system 600 can be considered a machine that reads the MEM/non-transitory program storage device and that executes the computer program code or executable program of instructions stored thereon. While the entity of FIG. 6 is shown as having one MEM, in practice each may have multiple discrete memory devices and the relevant algorithm(s) and executable instructions/program code may be stored on one or across several such memories. The source files that embody the video streams of images that are input to the device/system 600 from the various cameras may be previously recorded and stored on the same MEM 616 as the executable PROG 618 that implements these teachings, or on a different MEM. For the case the video inputs represent a feed of a live event, such a different memory may for example be a frame memory or video buffer.

The PROG 618 is assumed to include program instructions that, when executed by the associated one or more DPs 614, enable the system/device 600 to operate in accordance with exemplary embodiments of this invention. That is, various exemplary embodiments of this invention may be implemented at least in part by computer software executable by the DP 614 of the video processing device/system 600; and/or by hardware, or by a combination of software and hardware (and firmware). Note also that the audio processing device/system 600 may also include dedicated processors 615. The electrical interconnects/busses between the components at FIG. 9 are conventional and not separately labelled.

The computer readable MEM 616 may be of any memory device type suitable to the local technical environment and may be implemented using any suitable data storage technology, such as semiconductor based memory devices, flash memory, magnetic memory devices and systems, optical memory devices and systems, fixed memory and removable memory. The DPs 614, 615 may be of any type suitable to the local technical environment, and may include one or more of general purpose computers, special purpose computers, microprocessors, digital signal processors (DSPs), audio processors and processors based on a multicore processor architecture, as non-limiting examples. The modem 612 may be of any type suitable to the local technical environment and may be implemented using any suitable communication technology, and may further encode the combined multi-camera video stream prior to distribution over the network to the end user VR devices.

A computer readable medium may be a computer readable signal medium or a non-transitory computer readable storage medium/memory. A non-transitory computer readable storage medium/memory does not include propagating signals and may be, for example, but not limited to, an electronic, magnetic, optical, electromagnetic, infrared, or semiconductor system, apparatus, or device, or any suitable combination of the foregoing. Computer readable memory is non-transitory because propagating mediums such as carrier waves are memoryless. More specific examples (a non-exhaustive list) of the computer readable storage medium/memory would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A method comprising:
selecting a first panoramic image from a first video stream comprising a series of stitched images captured by multiple cameras of a first video camera array;
selecting a second panoramic image from a second video stream comprising a series of stitched images captured by multiple cameras of a second video camera array not co-located with the first camera array;
computing a rotation between the first and second panoramic images such that, when applied, the first and/or the second panoramic images are rotated relative to one another such that at least one common object is oriented to a common field of view position in both the first and second panoramic images;
and at least one of:
outputting the first video stream, the second video stream, and an indication of the computed rotation; and
outputting the first video stream and the second video stream with the computed rotation applied thereto.

2. The method according to claim 1, further comprising:
receiving with the first video stream sensor data that identifies a first direction at which a first camera of the first camera array was facing while capturing a portion of the first panoramic image in which the common object is in the field of view; and
receiving with the second video stream sensor data that identifies a second direction at which a second camera of the second camera array was facing while capturing a portion of the second panoramic image in which the common object is in the field of view;
wherein computing the rotation comprises:
selecting a reference direction;
aligning one or both of the first and second directions to the reference direction; and
computing the rotation in relation to the reference direction.

3. The method according to claim 2, wherein computing the rotation comprises:
calculating a first rotation offset between the first direction and the reference direction; and/or
calculating a second rotation offset between the second direction and the reference direction; wherein if the indication of the computed rotation is output the indication of the computed rotation that is output is an indication of the calculated first and/or second rotation offset.

4. The method according to claim 2, wherein selecting the reference direction comprises choosing one of the first and second directions.

5. The method according to claim 2, wherein each of the first and second video camera arrays is a virtual reality video camera array comprising at least five cameras with overlapping fields of view.

6. The method according to claim 1, wherein computing the rotation comprises:
selecting as a reference direction a viewpoint direction of a portion of the first panoramic image in which the common object is in the field of view; and
calculating a rotational displacement between the reference direction and a viewpoint direction of a portion of the second panoramic image in which the common object is in the field of view; wherein if the indication of the computed rotation is output the indication of the computed rotation that is output is an indication of the calculated rotational displacement.

7. The method according to claim 1, wherein the computed rotation is a first computed rotation that when applied rotates the first panoramic image relative to the second panoramic image, the method further comprising:
selecting a third panoramic image from a third video stream comprising a series of stitched images captured by multiple cameras of a third video camera array not co-located with the first nor the second video camera arrays; and
computing a second rotation between at least the second and third panoramic images such that, when applied, the third panoramic image is rotated relative to the second panoramic image such that the at least one common object is oriented to the common field of view position in both the second and third panoramic images; wherein the outputting comprises at least one of:
outputting the first video stream, the second video stream, the third video stream and indications of the first and second computed rotations; and
outputting the first video stream and the second video stream and the third video stream with the first and second computed rotation applied thereto.

8. The method according to claim 1, wherein the method is performed dynamically as the first and second video camera arrays capture a live event via the respective first and second video streams.

9. The method according to claim 8, wherein the method is performed multiple times across multiple common objects of the first and second panoramic images, wherein each performance of the method computes a rotation such that at least one of the multiple common objects is oriented to a different common field of view position in both the first and second panoramic images.

10. The method according to claim 1, wherein the method is performed continuously on the first and second video streams such that each pair of first and second panoramic images on which the method is performed are simultaneously captured by the respective first and second video camera arrays.

11. A computer readable memory storing executable program code that, when executed by one or more processors, cause an apparatus to perform actions comprising:
selecting a first panoramic image from a first video stream comprising a series of stitched images captured by multiple cameras of a first video camera array;
selecting a second panoramic image from a second video stream comprising a series of stitched images captured by multiple cameras of a second video camera array not co-located with the first camera array;
computing a rotation between the first and second panoramic images such that, when applied, the first and/or the second panoramic images are rotated relative to one another such that at least one common object is oriented to a common field of view position in both the first and second panoramic images;
and at least one of:
outputting the first video stream, the second video stream, and an indication of the computed rotation; and
outputting the first video stream and the second video stream with the computed rotation applied thereto.

12. The computer readable memory according to claim 11, the actions further comprising:
receiving with the first video stream sensor data that identifies a first direction at which a first camera of the first camera array was facing while capturing a portion of the first panoramic image in which the common object is in the field of view; and
receiving with the second video stream sensor data that identifies a second direction at which a second camera of the second camera array was facing while capturing a portion of the second panoramic image in which the common object is in the field of view; wherein computing the rotation comprises:
selecting a reference direction;
aligning one or both of the first and second directions to the reference direction; and
computing the rotation in relation to the reference direction.

13. The computer readable memory according to claim 11, wherein computing the rotation comprises:
selecting as a reference direction a viewpoint direction of a portion of the first panoramic image in which the common object is in the field of view; and
calculating a rotational displacement between the reference direction and a viewpoint direction of a portion of the second panoramic image in which the common object is in the field of view; wherein if the indication of the computed rotation is output the indication of the computed rotation that is output is an indication of the calculated rotational displacement.

14. The computer readable memory according to claim 11, wherein the computed rotation is a first computed rotation that when applied rotates the first panoramic image relative to the second panoramic image, the actions further comprising:
selecting a third panoramic image from a third video stream comprising a series of stitched images captured by multiple cameras of a third video camera array not co-located with the first nor the second video camera arrays; and
computing a second rotation between at least the second and third panoramic images such that, when applied, the third panoramic image is rotated relative to the second panoramic image such that the at least one common object is oriented to the common field of view position in both the second and third panoramic images; wherein the outputting comprises at least one of:
outputting the first video stream, the second video stream, the third video stream and indications of the first and second computed rotations; and
outputting the first video stream and the second video stream and the third video stream with the first and second computed rotation applied thereto.

15. The computer readable memory according to claim 11, wherein the actions are performed dynamically as the first and second video camera arrays capture a live event via the respective first and second video streams.

16. The computer readable memory according to claim 11, wherein the actions are performed continuously on the first and second video streams such that each pair of first and second panoramic images on which the actions are performed are simultaneously captured by the respective first and second video camera arrays.

17. An apparatus comprising:
at least one computer readable memory storing computer program instructions; and
at least one processor; wherein the at least one memory with the computer program instructions is configured with the at least one processor to cause the apparatus to at least:
select a first panoramic image from a first video stream comprising a series of stitched images captured by multiple cameras of a first video camera array;
select a second panoramic image from a second video stream comprising a series of stitched images captured by multiple cameras of a second video camera array not co-located with the first camera array;
compute a rotation between the first and second panoramic images such that, when applied, the first and/or the second panoramic images are rotated relative to one another such that at least one common object is oriented to a common field of view position in both the first and second panoramic images;
and at least one of:
output the first video stream, the second video stream, and an indication of the computed rotation; and
output the first video stream and the second video stream with the computed rotation applied thereto.

18. The apparatus according to claim 17, wherein the at least one memory with the computer program instructions is configured with the at least one processor to cause the apparatus further to:
receive with the first video stream sensor data that identifies a first direction at which a first camera of the first camera array was facing while capturing a portion of the first panoramic image in which the common object is in the field of view; and
receive with the second video stream sensor data that identifies a second direction at which a second camera of the second camera array was facing while capturing a portion of the second panoramic image in which the common object is in the field of view; wherein computing the rotation comprises:
selecting a reference direction;
aligning one or both of the first and second directions to the reference direction; and
computing the rotation in relation to the reference direction.

19. The apparatus according to claim 17, wherein computing the rotation comprises:
selecting as a reference direction a viewpoint direction of a portion of the first panoramic image in which the common object is in the field of view; and
calculating a rotational displacement between the reference direction and a viewpoint direction of a portion of the second panoramic image in which the common object is in the field of view; wherein if the indication of the computed rotation is output the indication of the computed rotation that is output is an indication of the calculated rotational displacement.

20. The apparatus according to claim 17, wherein the computed rotation is a first computed rotation that when applied rotates the first panoramic image relative to the second panoramic image; and the at least one memory with the computer program instructions is configured with the at least one processor to cause the apparatus further to:
select a third panoramic image from a third video stream comprising a series of stitched images captured by multiple cameras of a third video camera array not co-located with the first nor the second video camera arrays; and
compute a second rotation between at least the second and third panoramic images such that, when applied, the third panoramic image is rotated relative to the second panoramic image such that the at least one common object is oriented to the common field of view position in both the second and third panoramic images; wherein the outputting comprises at least one of:
outputting the first video stream, the second video stream, the third video stream and indications of the first and second computed rotations; and
outputting the first video stream and the second video stream and the third video stream with the first and second computed rotation applied thereto.

21. The apparatus according to claim 17, wherein the apparatus is caused to select, compute and output as said dynamically as the first and second video camera arrays capture a live event via the respective first and second video streams.

22. The apparatus according to claim 17, wherein the apparatus is caused to select, compute and output as said continuously on the first and second video streams such that each pair of first and second panoramic images on which the actions are performed are simultaneously captured by the respective first and second video camera arrays.
